(19) United States
(12) Patent Application Publication
(10) Pub. No.: US 2015/0134748 A1
(43) Pub. Date: May 14, 2015

(54) ONLINE AND OFFLINE COOPERATION TO OBTAIN INPUT TO AUGMENT RECORDING OF MEETING

(71) Applicant: CISCO TECHNOLOGY, INC., San Jose, CA (US)

(72) Inventors: Ling (Rory) Zhang, Hefei (CH); Bin Zhu, Suzhou (CH); Zi (James) Zhou, Hefei (CH); Hong (Juanny) Wang, Hangzhou (CH); Guang Xu, Hefei (CH); Ling Zhu, Hefei (CH)

(73) Assignee: CISCO TECHNOLOGY, INC., San Jose, CA (US)

(21) Appl. No.: 14/077,483

(22) Filed: Nov. 12, 2013

(51) Int. Cl. H04L 29/06; H04L 12/58

(52) U.S. Cl. CPC H04L 65/403; H04L 51/04
USPC 709/206; 709/204

(57) ABSTRACT

In one embodiment, a method includes initiating a record of a session, and determining when, during the session, an input is requested from a first party. The session includes at least a first participant. The method also includes providing an indication during the session, the indication being arranged to indicate that the input is requested from the first party, the indication being provided in the record, and notifying the first party that the input is requested from the first party. Notifying the first party that the input is requested from the first party includes providing the first party with an interface which enables the first party to provide the input.

### TECHNICAL FIELD

The disclosure relates generally to conferencing systems. More particularly, the disclosure relates to allowing input from a non-attending party to be solicited during a recorded conference session, and provided after a recording of the conference session is created, and stored in an updated recording of the conference session.

### BACKGROUND

The use of collaborative systems, e.g., conferencing systems, enables parties who are not at the same physical location to efficiently meet and share information. Many conference sessions or meetings are recorded, and recordings of the conference sessions or meetings are stored so that the recordings may be accessed at substantially any time.

During many conference sessions or meetings, questions may arise which may require input to be provided offline, or after the conference session or meeting. When answers to questions which arise during a conference session are provided after the conference session ends, there is generally no efficient way of ensuring that the answers are provided to those who were in attendance at the conference session. As such, the answers may not be efficiently provided to those who may be interested in the answers, e.g., participants in the meeting.

### BRIEF DESCRIPTION OF THE DRAWINGS

The disclosure will be readily understood by the following detailed description in conjunction with the accompanying drawings in which:

FIG. 1 is a process flow diagram which illustrates one method of soliciting input from a party with respect to a meeting, e.g., a meeting at which the party was not in attendance, in accordance with an embodiment.

FIG. 2 is a process flow diagram which illustrates one method of obtaining input from a party with respect to a meeting, e.g., a meeting at which the party was not in attendance, in accordance with an embodiment.

FIG. 3 is a process flow diagram which illustrates one method of creating an updated recording, e.g., a recording of a meeting, based on input provided after the meeting in accordance with an embodiment.

FIG. 4 is a diagrammatic representation of a system in which input from a party is identified as being desired during a meeting, and provided by the party after the meeting, in accordance with an embodiment.

FIG. 5 is a block diagram representation of a node, e.g., a server, that is suitable for use in supporting a meeting during which input from a party is identified as being desired and for use in obtaining the input after the meeting in accordance with an embodiment.

FIG. 6A is a diagrammatic representation of a window or a portion associated with of a recording or record of a meeting that indicates input is desired from a party not in attendance at the meeting in accordance with an embodiment.

FIG. 6B is a diagrammatic representation of a window or portion of a recording or record of a meeting, e.g., window 680 of FIG. 6A, after input has been provided from a party that was not in attendance at the meeting in accordance with an embodiment.

### DESCRIPTION OF EXAMPLE EMBODIMENTS

### General Overview

According to one aspect, a method includes initiating a record of a session, and determining when, during the session, an input is requested from a first party. The session includes at least a first participant. The method also includes providing an indication during the session, the indication being arranged to indicate that the input is requested from the first party, the indication being provided in the record, and notifying the first party that the input is requested from the first party. Notifying the first party that the input is requested from the first party includes providing the first party with an interface which enables the first party to provide the input.

### DESCRIPTION

Often, during a collaborative session such as a conference session or a meeting, issues may arise which may necessitate input provided after the collaborative session has ended. For example, input from a party not in attendance at a meeting may be requested, and such input may be provided by the party after the meeting has ended. When a response to a request for input is provided after a meeting ends, the ability to efficiently provide a response to interested parties, as for example parties that were in attendance at the meeting, would enable information provided in the response to be readily distributed to the interested parties.

In one embodiment, when a session or a meeting is recorded, additional information provided after the session is recorded may be incorporated into a record or a recording of the session. As such, an updated record or recording of the session may effectively be created from the original record of the session and inputs provided after the session has ended. Hence, any time the updated record is accessed, additional information provided after the session has ended is available.

During a meeting for which a record is being made, it may be determined that input from a particular party, e.g., a party not in attendance at the meeting, is desired. By substantially augmenting the record to provide an indication that input is desired from the particular party, the particular party may readily identify a location within the record at which is or her input is desired. A party may be notified, as for example by a conference server, when his or her input is desired with respect to a record of a meeting. Upon being notified that his or her input is desired with respect to a record of a meeting, a particular party may access the record and identify a portion of the record at which his or her input is needed. The particular party may then provide his or her input, which may then be used to update the record or to produce an updated version of the record. Once the updated record is created, the updated record may be stored such that any party who accesses the updated record will be able to access the input provided by the particular party. The ability to incorporate information provided by a party, and related to the contents of a record of a meeting, substantially into the record allows the additional information to be readily shared.

In general, it may be determined during a meeting that input, e.g., input from a party that is not a participant in the meeting, is desired, and such input may be solicited and provided after the meeting has ended. That is, it may be determined during a meeting, e.g., online, that input is desired from a particular party, and the particular party may provide the desired input after the meeting, e.g., offline.

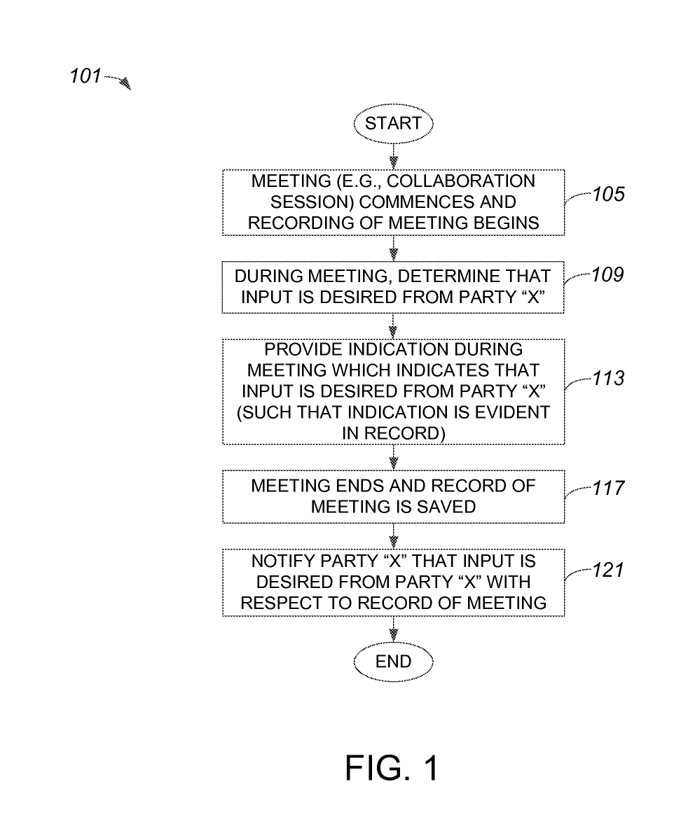

Referring initially to FIG. 1, one method of soliciting input from a party with respect to a conference session or a meeting, e.g., a meeting at which the party was not in attendance, will be described in accordance with an embodiment. A method 101 of soliciting input from a party with respect to a meeting begins at step 105 in which a meeting, or a collaboration session, commences and a record of the meeting is effectively initiated. Such a meeting may be a virtual meeting in which meeting attendees may “attend” and/or otherwise participate in the virtual meeting using telephones and/or computing systems. A virtual meeting may include audio and/or video components and, as such, a record of a virtual meeting may include audio and/or video components. In one embodiment, a record of a meeting may begin when a host of the meeting initiates a process of recording the meeting.

After the meeting commences and the record of the meeting is effectively initiated, the meeting proceeds and may be supported by a conference server. During the meeting, it is determined in step 109 that input is desired from party “X”. That is, it is input from party “X” is effectively requested. In the described embodiment, party “X” is not in attendance at the meeting. It should be appreciated, however, that party “X” may instead be in attendance at the meeting but unable to provide input until after the meeting. In step 113, an indication is provided which indicates that input is desired from party “X”. The indication is generally arranged such that the indication is evident in the record. By way of example, the indication may be a visual prompt which identifies party “X” and includes a request for input, and/or the indication may be an audial prompt which identifies party “X” and includes a request for input.

The meeting ends and the record of the meeting is saved, e.g., stored in a database, in step 117. Once the meeting ends and the record of the meeting or meeting record is saved, party “X” is notified that his or her input is desired with respect to the recording of the meeting. Party “X” may be notified by a conference server that his or her input is desired in any suitable manner. By way of example, party “X” may be notified through an email message, an instant message, a text message, and/or a phone call. A notification sent to party “X” may include the record of the meeting, or may include a link or a universal record locator (URL) address through which the record of the meeting may be accessed. In one embodiment, the notification identifies wherein the record input from party “X” is desired. That is, the notification provides party “X” with information relating to a point in the record or a portion of the record at which input from party “X” is requested. After party “X” is notified that his or her input is desired with respect to the record of the meeting, the method of soliciting input from a party is completed.

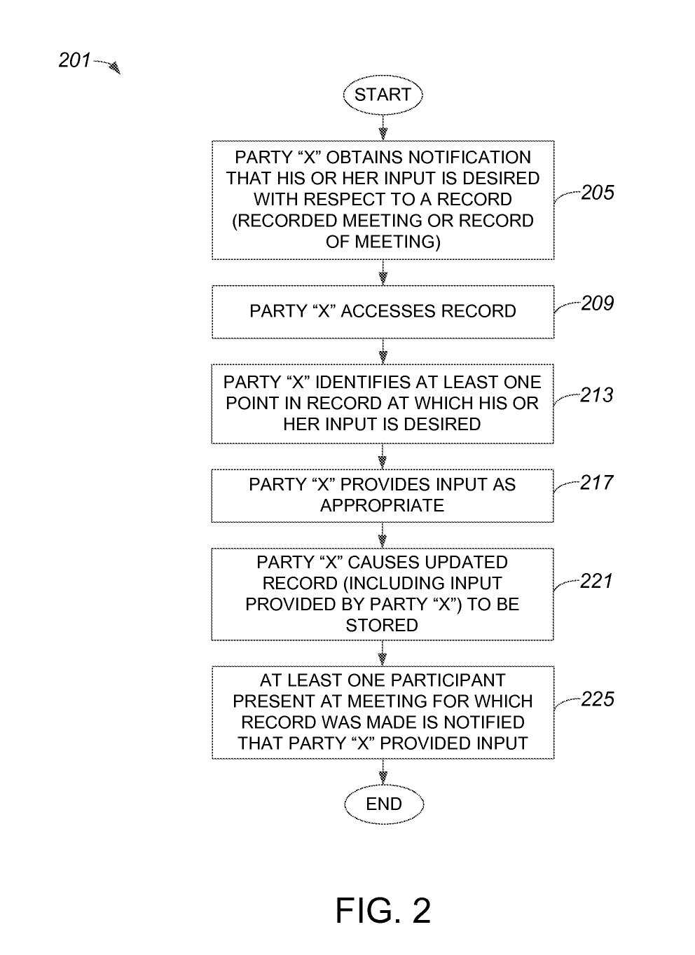

With reference to FIG. 2, one method of obtaining input from a party with respect to a conference session or a meeting, e.g., a meeting at which the party was not in attendance, will be described in accordance with an embodiment. A method 201 of obtaining input from a party with respect to a meeting begins at step 205 in which party “X” obtains a notification, as for example from a conference server, that his or her input is desired with respect to a recording made of a meeting. As previously mentioned, the notification obtained by party “X” may be an email message, an instant message, a text message, and/or a phone call.

After party “X” obtains the notification that his or her input is desired, party “X” accesses a record in step 209. If the record is provided to party “X” in a file, e.g., sent as an attachment to an email message, party “X” may access the recording by opening the file. If a link or a URL to the record is provided to party “X”, the party “X” may access the record using the link or the URL.

Once party “X” accesses the record, party “X” identifies at least one point in the record at which his or her input is desired in step 213. In one embodiment, the record provides an indication which identifies a point in the meeting at which input from party “X” is desired. It should be appreciated that a notification obtained by party “X” which indicates that his or her input is desired may also identify at least one point in the meeting at which such input is desired.

In step 217, party “X” provides input as appropriate. By way of example, when a record provides or otherwise includes an indication which indicates that approval from party “X” is desired at a particular point in the record, party “X” may provide approval with respect to the particular point in the record. In general, any suitable input may be provided by party “X”. Suitable input may include, but is not limited to including, comments, images, documents, and/or videos.

Once party “X” provides input, then process flow moves to step 221 in which party “X” causes an updated record to be stored. It should be appreciated that the updated record generally includes input provided by party “X”. That is, the updated record is generally a substantially revised version of the record accessed in step 209 that includes input provided by party “X” in step 217. In one embodiment, the updated record essentially overwrites, or otherwise replaces, the record accessed in step 209.

After party “X” causes the updated record to be stored, at least one participant who was present at the meeting for which the record was made is notified in step 225 that party “X” provided requested input. In other words, a notification is sent to at least one participant of the meeting to indicate that requested input has been provided, and that an updated record of the meeting is available. The method of obtaining input from a party is completed upon notifying at least one participant who was present at the meeting that party “X” has provided input.

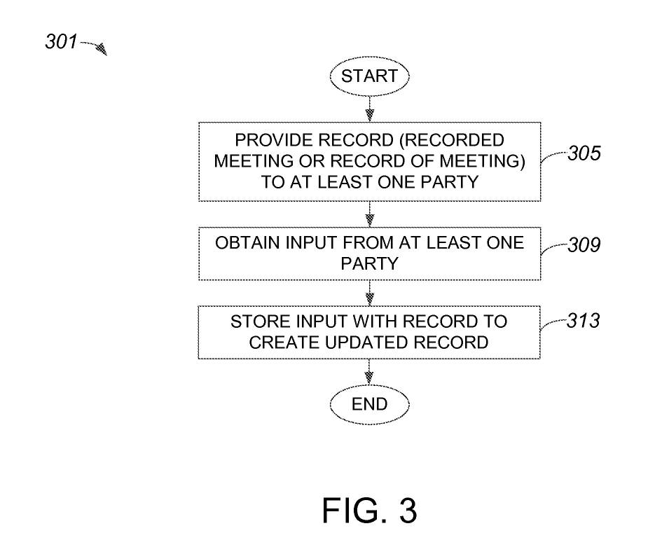

In general, once desired input is provided with respect to a record of a conference session or a meeting, the record of the conference session or meeting may be updated to include the input. FIG. 3 is a process flow diagram which illustrates one method of creating an updated record, e.g., a recording of a meeting, based on input provided after the meeting in accordance with an embodiment. A method 301 of creating an updated record begins at step 305 in which a record, e.g., a recorded meeting or a record of a meeting, is provided to at least one party. Input is obtained from the party in step 309 with respect to the record. Input may be obtained from the party using any suitable method. Suitable methods include, but are not limited to including, obtaining data from an input/output (I/O) device used by the party, obtaining a text string from the party, and/or obtaining voice input from the party.

After input is obtained from the party, the obtained input is stored with the record in step 313 to effectively create an updated recording. That is, a substantially modified or amended record that includes the obtained input is produced, and the modified or amended record may be stored, as for example in place of the record provided to the party in step 305. Upon storing the input with the record to create an updated record, the method of creating an updated record is completed.

During the course of a session or a meeting that is recorded, participants in the session or the meeting may generally interact with a conference server, and the conference server may cause the session or the meeting to be recorded. After a record of the session or the meeting is generated, a party may provide input that may be used by the conference server in conjunction with the recording to create an updated record.

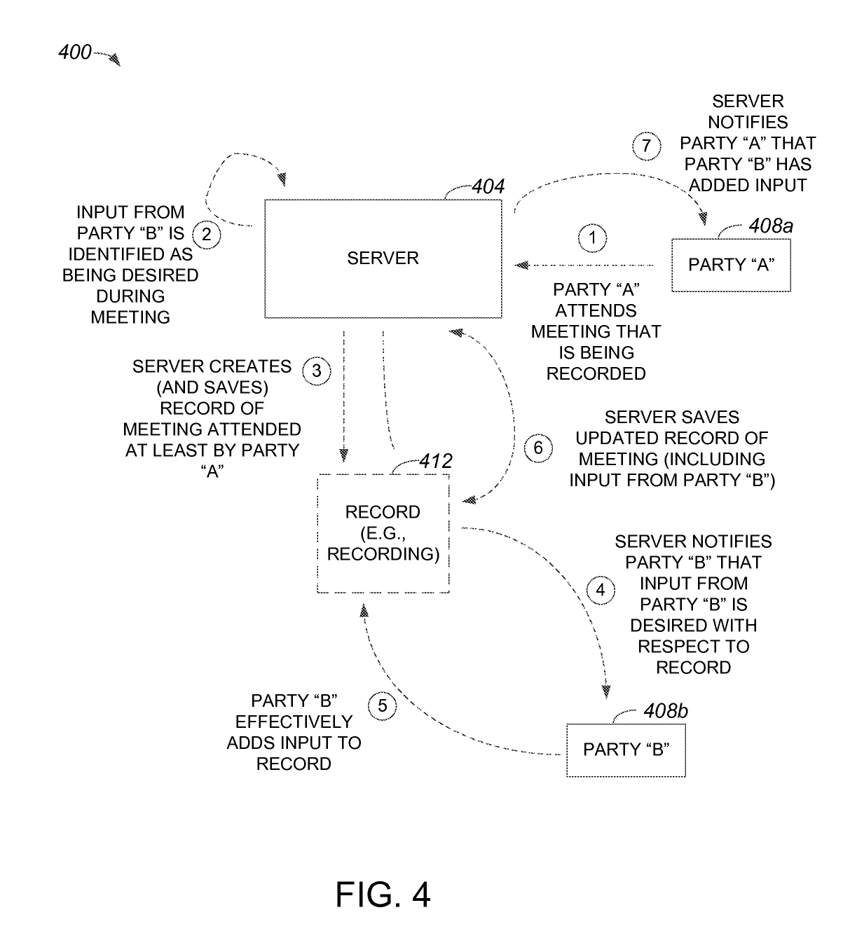

FIG. 4 is a diagrammatic representation of a system that includes a conference server that supports a meeting, and in which input from a party is identified as being desired during a meeting and provided by the party after the meeting in accordance with an embodiment. A system 400 includes a server 404, as for example a conference server that supports a multimedia conference session or meeting. Any number of parties 408a, 408b may generally interact with server 404 during and/or after a meeting. In the embodiment as shown, party “A” 408a participates in a meeting supported by server 404, and party “B” 408b effectively interacts with server 404 once a record 412 of the meeting is available. As will be appreciated by those skilled in the art, party “A” 408a may participate in a meeting supported by server 404 using a device such as a computer or a phone, and party “B” 408b may effectively interact with server 404 using a device such as a computer or a phone.

At a time t1, party “A” 408a attends a meeting supported by, e.g., hosted on, server 404. The meeting may be initiated at approximately time t1, when party “A” 408a begins attending the meeting. At a time t2 during the meeting, input from party “B” 408b is identified as being desired. At a time t3, after input from party “B” 408b is identified as being desired, server 404 creates and saves record 412 of the meeting. It should be appreciated that record 412 typically covers the duration of the meeting. In other words, record 412 captures up to substantially all of the meeting beginning at approximately time t1 and ending at approximately time t3. Record 412 may be stored in a memory or a database (not shown), and may be accessible to party “A” 408a and party “B” 408b.

At a time t4, server 404 notifies party “B” 408b that input from party “B” 408b is requested, e.g., desired or otherwise needed, with respect to record 412. Party “B” 408b may interact with record 412, and at a time t5, party “B” 408b effectively adds input to record 412. Typically, party “B” 408b essentially adds input at points or locations in record 412 at which input from party “B” 408b is desired.

Once party “B” 408b effectively adds input to record 412, server 404 may cause an updated version of record 412 to be saved at time t6. The updated version of record 412 may be, in one embodiment, an updated recording that includes record 412 and input provided by party “B” 408b. After the updated version of record 412 is stored, server notifies party “A” that party “B” has added input at time t7.

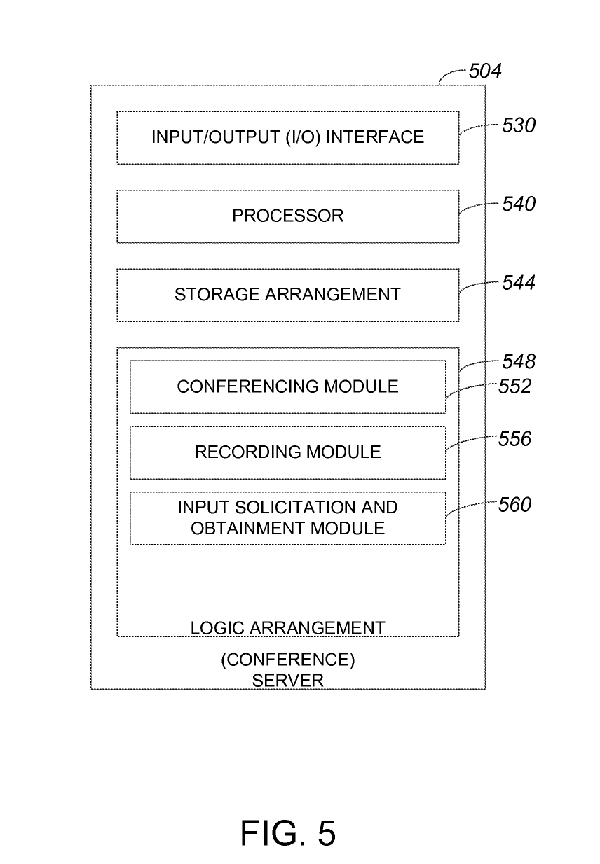

In general, a node or element associated with a conferencing system may be arranged to support a meeting, to record the meeting to generate a record, to solicit input from parties with the recording, and to store an updated recording that includes input provided by parties. With reference to FIG. 5, a node, e.g., a server, that is suitable for use in supporting a session or a meeting during which input from a party is identified as being desired and for use in obtaining the input after the meeting in accordance with an embodiment. A node 504 may generally be an element in a network. In one embodiment, node 504 is a conference server that is a part of an overall conferencing system.

Node 504 includes an I/O interface 530 which allows node 504 to communicate on a network. Node 504 also includes a processor 540 and a storage arrangement 544. Storage arrangement 544 is arranged to store information, as for example a record, associated with a conference session or a meeting. Although storage arrangement 544 is shown as being a part of node 504, it should be appreciated that storage arrangement 544 may instead be external to node 504 but accessible to node 504.

A logic arrangement 548, which is also a part of node 504, includes hardware and/or software logic that is configured to be executed by processor 540. Logic arrangement 548 includes a conferencing module 552 that is configured to support conference sessions and meetings, e.g., collaboration sessions. Conferencing module 552 may generally be arranged to support a conference bridge.

Logic arrangement 548 also includes a recording module 556, as well as an input solicitation and obtainment module 560. Recording module 556 is arranged to record conference sessions or meetings. Records created by recording module 556 may include, but are not limited to including, audio recordings, video recordings, and/or multimedia recordings. Input solicitation and obtainment module 560 determines when, during a conference session or meeting, input from a particular party, e.g., a party not in attendance at the conference session or meeting, is desired. Input solicitation and obtainment module 560 may cause indications of when input is desired, as well as from whom the input is desired, to be substantially indicated in a record of a conference session or meeting. Further, input solicitation and obtainment module 560 may notify parties when their input is desired with respect to a record, obtain input from the parties, and cause an updated record to be substantially generated to include input obtained from the parties.

Any suitable interface may be used to obtain input from a party with respect to a record. In one embodiment, when a recorded meeting includes a window displayed on a computer screen, an interface may be included in the window which indicates when input is requested and a party whom the input is requested. Such an interface may also be arranged to allow a party to provide input, and to indicate when the input was provided by the party.

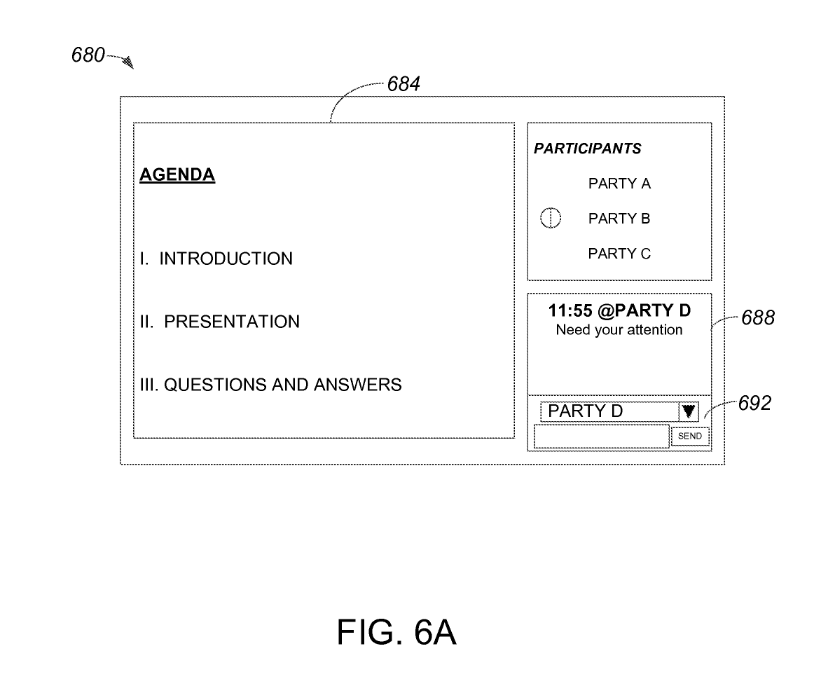

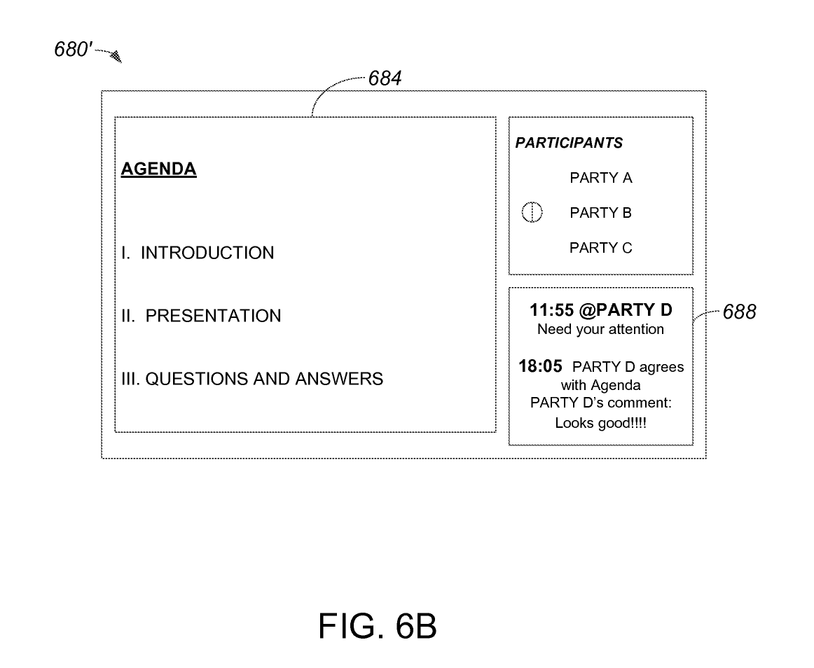

FIG. 6A is a diagrammatic representation of a window displayed on a display screen that depicts a screen captured in record of a meeting when input is desired from a party not in attendance at the meeting in accordance with an embodiment. A window 680 includes a section 684 in which content, e.g., active content, is displayed. Window 680 also includes an overall interface that includes an interface 688 which identifies a party and indicates when input is requested from that party, and an interface 692 which identifies the party from which input is desired, and provides an area in which the input may be entered or otherwise provided. It should be appreciated that when a notification is sent to the party from which input is desired, the notification may include the same information displayed in interface 692. In other words, a notification sent to the party may effectively identify information that is requested from the party.

FIG. 6B is a diagrammatic representation of a window, e.g., window 680 of FIG. 6A, that is part of a record after input has been provided from a party that was not in attendance at the meeting in accordance with an embodiment. Once a party from which input is requested provides input, interface 688 is updated to indicate when the input was provided and also displays the input. The updated interface 688 then becomes part of the record.

Although only a few embodiments have been described in this disclosure, it should be understood that the disclosure may be embodied in many other specific forms without departing from the spirit or the scope of the present disclosure. By way of example, input provided with respect to a recording of a meeting is not limited to being provided by parties who were not in attendance at the meeting or were not participating in the meeting. Input may be requested, in one embodiment, from a participant in the meeting. For instance, a participant in the meeting may be unable to provide input during the meeting, but may be able to provide input after he or she is able to gather more information after the meeting. A recording may be arranged to indicate that a participant in the meeting is to provide input at a later time, and the recording may be updated to include the input once the participant is able to provide input after the meeting.

Any suitable interface may generally be used to provide an indication within a record that input is requested. While an indication may indicate a type of input requested, a party from which input is requested, and/or as a time at which input was requested, it should be appreciated that an indication is not limited to including type, a party, and/or a time. For example, an indication may also identify a party that is requesting input.

While input has generally been described as being provided with respect to a record of a meeting and stored as a part of an updated recording, it should be appreciated that input is not limited to being provided with respect to a record of a meeting. Input may generally be requested and/or provided in any file or record of a meeting. By way of example, input may be requested and/or provided in a log or a transcript of a meeting. In other words, a transcript of a collaboration session or a meeting may be updated to include information provided in response to a request after the collaboration session or meeting has ended.

As previously mentioned, a record or a copy of a record may essentially be provided to each party from which input is desired with respect to the recording. In one embodiment, a master record may be maintained such that when parties provide input to copies of the record, the inputs provided by the parties are all incorporated into the master record. In another embodiment, updated versions of a particular record may be obtained from substantially all parties from which input is desired, and a master recording may be created from the updated versions of the particular record.

A notification which is sent to a party to indicate that input for the party is requested with respect to a session or a meeting has generally been described as being sent after the session or meeting has ended. It should be understood that a notification is not limited to being sent after a session or meeting has ended. By way of example, a notification may be sent to a party at substantially the same time that it is determined that input from the party is desired without departing from the spirit or the scope of the disclosure.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
initiating a record of a session, the session including at least a first participant;
determining when, during the session, an input is requested from a first party;
providing an indication during the session, the indication being arranged to indicate that the input is requested from the first party, the indication being provided in the record; and
notifying the first party that the input is requested from the first party, wherein notifying the first party that the input is requested from the first party includes providing the first party with an interface which enables the first party to provide the input.

2. The method of claim 1 wherein notifying the first party that the input is requested from the first party further includes providing the record to the first party, and wherein the interface which enables the first party to provide the input is included in the record.

3. The method of claim 1 wherein notifying the first party that the input is requested from the first party includes providing the first party with a notification that identifies at least one point in the record at which the input is requested.

4. The method of claim 1 wherein the first party is not included in the session, and wherein notifying the first party that the input is requested includes notifying the first party after the session ends.

5. The method of claim 1 wherein the first party is not included in the session, and wherein notifying the first party that the input is requested includes notifying the first party before the session ends.

6. The method of claim 1 wherein notifying the first party that the input is requested from the first party includes one selected from a group including sending an email to the first party, sending a text message to the first party, and sending an instant message to the first party.

7. The method of claim 1 further including:
storing the record when the session is ended;
obtaining the input from the first party after storing the record when the session is ended; and
after obtaining the input, updating the record to include the input.

8. A tangible, non-transitory computer-readable medium comprising computer program code, the computer program code, when executed, configured to:
initiate a record of a session, the session including at least a first participant;
determine when, during the session, an input is requested from a first party;
provide an indication during the session, the indication being arranged to indicate that the input is requested from the first party, the indication being provided in the record; and
notify the first party that the input is requested from the first party, wherein the computer program code configured to notify the first party that the input is requested from the first party is further configured to provide the first party with an interface which enables the first party to provide the input.

9. The tangible, non-transitory computer-readable medium comprising computer program code of claim 8 wherein the computer program code configured to notify the first party that the input is requested from the first party is further configured to provide the record to the first party, and wherein the interface which enables the first party to provide the input is included in the record.

10. The tangible, non-transitory computer-readable medium comprising computer program code of claim 8 wherein the computer program code configured to notify the first party that the input is requested from the first party is further configured to provide the first party with a notification that identifies at least one point in the record at which the input is requested.

11. The tangible, non-transitory computer-readable medium comprising computer program code of claim 8 wherein the first party is not included in the session, and wherein the computer program code configured to notify the first party that the input is requested is further configured to notify the first party after the session ends.

12. The tangible, non-transitory computer-readable medium comprising computer program code of claim 8 wherein the first party is not included in the session, and wherein the computer program code configured to notify the first party that the input is requested is further configured to notify the first party before the session ends.

13. The tangible, non-transitory computer-readable medium comprising computer program code of claim 8 wherein the computer program code configured to notify the first party that the input is requested from the first party is further configured to send at least one selected from a group including an email to the first party, a text message to the first party, and an instant message to the first party.

14. The tangible, non-transitory computer-readable medium comprising computer program code of claim 8 wherein the computer program code is further configured to:
store the record when the session is ended;
obtain the input from the first party after storing the record when the session is ended; and
after obtaining the input, update the record to include the input.

15. An apparatus comprising:
a processor; and
a logic arrangement configured to be executed by the processor to record a session, wherein the logic arrangement includes a conferencing module configured to support a conference session, a recording module configured to create a record of the conference session, and an input solicitation and obtainment module, the input solicitation and obtainment module being configured to determine when an input is requested during the conference session from a first party, provide an indication in the record that the input is requested, and notify the first party that the input is requested.

16. The apparatus of claim 15 further including:
a storage arrangement, wherein the recording module is configured to store the record in the storage arrangement when the conference session is completed.

17. The apparatus of claim 16 wherein the input solicitation and obtainment module is further configured to obtain the input from the first party, to update the record to include the input, and to store the record including the input in the storage arrangement.

18. The apparatus of claim 17 wherein the conference session has a first participant, and wherein the input solicitation and obtainment module is still further configured to notify the first participant when the input has been obtained from the first party.

19. The apparatus of claim 15 wherein the input solicitation and obtainment module is configured to notify the first party that the input is requested by providing a notification to the first party, the notification including an indication of where in the record the input is to be provided by the first party.

20. The apparatus of claim 15 wherein the first party is not a participant in the conference session.
